(19) United States
(12) Patent Application Publication
(10) Pub. No.: US 2026/0247461 A1
(43) Pub. Date: Aug. 20, 2026

(54) System and method for generating dedicated temporary mesh network connections between multi-environment systems

(71) Applicant: Bank of America Corporation, Charlotte, NC (US)

(72) Inventors: Siten Sanghvi, Westfield, NJ (US); Naga Vamsi Krishna Akkapeddi, Charlotte, NC (US)

(21) Appl. No.: 19/057,358

(22) Filed: Feb. 19, 2025

(51) Int. Cl. H04W 76/15; H04W 24/00; H04W 84/18

(52) U.S. Cl. CPC H04W 76/15; H04W 24/00; H04W 84/18

(57) ABSTRACT

A system is configured to monitor actions on a source device. The system determines that the first action corresponds to a first operation (also referred to as a first wireless interaction) of checking an account balance operation at an ATM that is part of the plurality of target devices. The system then transmits a query request to each of the first target device and the second target device. In response to the query request, receive a first target device identifier from the first target device and a second target device identifier from the second target device. The system transmits a connection initiation request to the first target device and initiates a temporary mesh network connection between the source device and the first target device.

### TECHNICAL FIELD

The present disclosure relates generally to network communications and, more specifically, to a system and method for generating dedicated temporary mesh network connections between multi-environment systems.

### BACKGROUND

In a network environment, source devices (e.g., a smartwatch) are used to communicate data with target devices (e.g., Internet of Things (IoT) devices). These network environments allow wireless interaction between the source and target devices. Wireless interactions between these devices are vulnerable to malicious activities (e.g., eavesdropping attacks) by bad actors. Some of the technical challenges that occur when data is exchanged as part of the wireless interaction are controlling eavesdropping or unauthorized access to the data. These malicious activities may compromise network security as well as data security of sensitive user data as part of the wireless interaction. Existing systems are unable to provide secure communication between source devices and target devices. Existing systems rely on system failure reports to detect these attacks.

### SUMMARY

The disclosed system, described in the present disclosure, is particularly integrated into a practical application for generating dedicated temporary mesh network connections between multi-environment systems. The disclosed system addresses technical problems rooted in wireless communications, and achieves technical improvements to the network, the source and target devices used in wireless communications, and underlying computer systems that facilitate wireless communications between the source and target devices.

The system and method implemented by the system, as disclosed in the present disclosure, provide technical solutions to the technical problems discussed above by generating dedicated temporary mesh network connections between source devices (e.g., a mobile phone or a smartwatch) and target devices (e.g., an automated teller machine (ATM), vending machines, parking meters, or any other IoT device). Further, the system enables multiple dedicated temporary mesh networks to provide simultaneous data exchange between a target device and a plurality of source devices over individual dedicated temporary mesh networks.

Conventional technologies are not configured to provide a reliable and efficient solution for controlling eavesdropping or unauthorized access to data that may compromise network security and the data security of sensitive user data. In conventional approaches, for a wireless (e.g., near field communication (NFC)) interaction performed between a source device and a target device, the most common malicious activity is an eavesdropping attack. In an eavesdropping attack, interactions between the source device and the target device are intercepted. This attack typically occurs because a target device is compromised and/or a source device is compromised by malware attacks, causing the data exchanged as part of the interaction also to be compromised. Specifically, a request is generated in response to a wireless interaction between a source device and a target device, and bad actors intercept these requests to gain access to sensitive user data (e.g., payment account information, payment card number, etc.) and network security data (e.g., network server IP address or MAC address, etc.) that is part of the wireless interaction. Bad actors gaining access to sensitive user data and network security data may result in data exfiltration by transmitting confidential data to unauthorized devices. In some cases, the stolen data may be used to perform other unauthorized data interactions within the computing infrastructure and to gain access to computing systems (e.g., server devices) and cause system damage (e.g., data theft, compromised computing performance, device failure, etc.) to those other computing systems in communication with the server device. To remedy such harmful actions (i.e., system damage and data exfiltration), the affected computing systems must be taken offline until the root problem is identified, thus making it inaccessible until the problem is identified and remedied. When a computing system is taken offline it further may cause the computing systems to shut down or go offline and thus be unavailable to provide services. This results in, for example, under-utilization of the affected computing systems, resulting in reduced performance of the network. In a situation where multiple computing systems may go offline, it may result in disruption of network operations across the network. In some cases, the disruption of network operations across a network is often associated with unnecessary data redundancy and thus reduces the overall network performance. Further, multiple computing systems go out of service, this results in increased downtime that further generates inaccurate network resource usage patterns, which results in inaccurate network resource allocation. For example, if a computing system device (e.g., target devices such as an ATM) is located in a high-user interaction neighborhood, where ATM cash is withdrawn at a very high rate. In this situation, the ATM may be allocated higher network bandwidth to provide uninterrupted services to the users interacting with the ATM; however, when the ATM goes out of service (e.g., because of system damage), resulting in underutilization of the allocated network bandwidth. Further, this may result in an inaccurate usage pattern indicating that the ATM does not require higher bandwidth as the ATM is idle for long durations, resulting in incorrectly downgrading the resource allocation from higher bandwidth to lower bandwidth and thus creating network bottlenecks.

Conventional techniques suffer from several drawbacks in providing secure communication between source devices and target devices. Conventional technologies are unable to provide secure encrypted communications between source devices and target devices (e.g., devices from multiple vendors) operating in different environments (e.g., different operating systems). Since conventional techniques do not provide end-to-end encryption, they are not able to control access to data and, hence, are not able to evade attacks. Conventional technologies rely on failure reports to detect the attack after the attack. By the time these failure reports are received, the attack has done its intended damage. Embodiments of the present disclosure provide several practical applications and technical advantages that provide solutions to the problems discussed above in relation to conventional computing systems and networks.

Embodiments of the present disclosure provide several practical applications and technical advantages that provide solutions to the problems discussed above in relation to conventional computing systems and networks. The system is configured to monitor actions on a source device (e.g., a smartwatch). For example, the first action may include rotating a crown button of the smartwatch in a clockwise direction. In response, the system determines that the first action corresponds to a first operation (also referred to as a first wireless interaction) of checking, for example, an account balance operation at an ATM that is part of the plurality of target devices (the plurality of target devices includes an ATM). The system then identifies a first target device and a second target device from the plurality of target devices that are within a first threshold distance (e.g. a Bluetooth connectivity range of the source device) to the source device. The system then transmits a query request to each of the first target device and the second target device. The query request seeks identifying information from the first target device and the second target device. In response to the query request, receive a first target device identifier (e.g., ATM ABC) from the first target device (e.g., an ATM) and a second target device identifier (e.g., Vending machine XYZ) from the second target device (e.g., a vending machine). The system then displays the first target device identifier and the second target device identifier on the source device and receives a selection of the first target device identifier based on an input received from the source device.

The system, in response to receiving the selection of the first target device identifier, transmits a connection initiation request to the first target device. The connection initiation request is to initiate a temporary mesh network connection between the source device and the first target device. Transmitting the connection initiation request includes transmitting an encrypted first source token associated with the source device. The first source token comprises a source device identifier (e.g., Smartwatch A1) one or more source connection protocols compatible with the source device (e.g., near field communication (NFC) connection protocol, Wireless Fidelity (WiFi®) connection protocol, Bluetooth Low Energy (BLE®) connection protocol), and user credentials associated with the user of the source device. The target device decrypts the user credentials and determines if the user credentials match to previously stored user credentials. Upon a successful match of the user credentials, the target device transmits a first target token to the source device. The system then receives a first target token from the first target device. The first target token comprises one or more target connection protocols compatible with the first target device. The system, in response to receiving the first target token, compares one or more target connection protocols (e.g., include NFC, WiFi®, and BLE®) that are compatible with the target device with one or more source connection protocols (NFC, WiFi®, and BLE) that are compatible with the source device. The system in response to the comparison, determines if there are any connection protocols that are common to both the source connection protocols and the target connection protocols. Accordingly, the system determines that there are all three connection protocols (NFC, WiFi®, and BLE) are common to both the source connection protocols and the target connection protocols. Next, the system determines the number of source devices wirelessly connected to the target device on the first common connection protocol (e.g., NFC) is 4 devices; on the second common connection protocol (e.g., WiFi®) is 100 devices, and on the third common connection protocol (e.g., BLE® is 50 devices. The system then selects the common connection protocol that has the lowest number of devices. Accordingly, system determines that the first common connection protocol (e.g., NFC) that has 4 devices is the lowest number of devices. Thus, the system selects the first common connection protocol (e.g., NFC). In response to system selecting a particular common connection protocol (e.g., first common connection protocol (e.g., NFC)), the system initiates the temporary mesh network connection between the source device and the target device using the particular common connection protocol (e.g., first common connection protocol (e.g., NFC)). This temporary mesh network connection may utilize a transport layer security protocol (e.g., TLS 1.3) that provides end-to-end encryption for all the data exchanged between the source device and the target device in the temporary mesh network connection. Thus providing an end to end encrypted communication based on encrypted tokens (e.g., first source token and first target token.)

Thus, unlike conventional systems that are unable to provide secure communication between source devices and target devices, the disclosed system and method provides end-to-end secure communication between source devices and target devices. As explained above, when bad actors gain access to sensitive user data and network security data, it may cause system damage to those other computing systems in communication with the server device. By providing encrypted and dedicated temporary mesh network connections, bad actors are restricted from gaining access to sensitive user data and network security data, thus minimizing fraudulent activities during wireless interaction. As a result of restricting bad actors, the system stops system damage from occurring by evading unauthorized access to the server device. Further, by evading unauthorized access on the server device, the system mitigates the above-described harmful actions that may otherwise occur to the other computing systems in communication with the server device, thus saving downtime associated with affected computing systems and additionally saving resources that would otherwise be necessary to remediate affected computing systems, which in turn provides uninterrupted operations of the network. This leads to improved operational efficiency of computing systems because the computing systems are not required to be taken offline for remediation. Other examples of harmful actions that the disclosed system is able to evade before an attack may include service disruption of the computing systems, data espionage, and identity theft.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings, in which:

FIG. 1 is a schematic diagram of a system, in accordance with an embodiment of the present disclosure;

FIG. 2A illustrates the first target token of FIG. 1, in accordance with one or more embodiments of the present disclosure;

FIG. 2B illustrates a n-target token of FIG. 1, in accordance with one or more embodiments of the present disclosure; and

FIG. 2C illustrates the first target token of FIG. 1, in accordance with one or more embodiments of the present disclosure;

FIG. 2D illustrates a n-target token of FIG. 1, in accordance with one or more embodiments of the present disclosure; and

FIG. 3 illustrates an example flowchart of a method of the system of FIG. 1 for generating dedicated temporary mesh network connections between multi-environment systems.

### DETAILED DESCRIPTION OF THE DRAWINGS

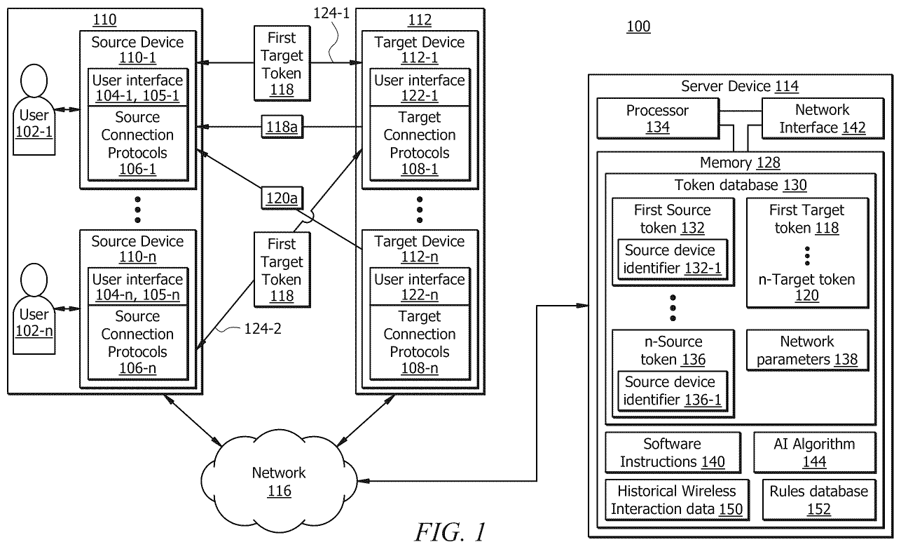

As described above, conventional technologies fail to provide secure communication between source devices and target devices. Embodiments of the present disclosure and its advantages may be understood by referring to FIGS. 1-3. FIGS. 1-3 is used to describe systems and methods for generating dedicated temporary mesh network connections between multi-environment systems, according to some embodiments.

### System Overview

FIG. 1 is a schematic diagram of a system 100, in accordance with certain embodiments of the present disclosure. As shown, system 100 includes source devices 110-1 to 110-n, target devices 112-1 to 112-n, and server device 114, operably connected to one another via a network 116. Network 116 enables communication among the components of the system 100. The source devices 110-1 to 110-n are collectively or individually referred to as source device 110. The target devices 112-1 to 112-n are collectively or individually referred to as target device 112. In general, system 100 generates one or more dedicated temporary mesh network connections 124 between one or more source devices 110 and one or more target devices 112.

### SYSTEM COMPONENTS

### Source Device

System 100 includes source devices 110-1 to 110-n, these are collectively referred to as source device 110. The source devices 110-1 to 110-n may generally be any device configured to process data. Source devices 110-1 to 110-n may also include, but are not limited to, a smartwatch, a personal computer, a desktop computer, a workstation, a server, a laptop, a tablet computer, a mobile phone (such as a smartphone), an Internet-of-Things (IoT) device, a wearable computing device, smart glasses or bracelets, phablets, other smart devices, devices configured for wired or wireless RF (Radio Frequency) communication, or any other suitable type of device. Each of the source devices 110-1 to 110-n includes a user interface (e.g., 104-1 to 104-n), for example, user interface 104-1 is associated with source device 110-1, and user interface 104-n is associated with source device 110-n. The source devices 110-1 to 110-n may also include a display, a microphone, a camera, a keypad, or other appropriate equipment usable by a user. Source devices 110-1 to 110-n are utilized to perform wireless interactions with target devices 112-1 to 112-n.

### Source Connection Protocols

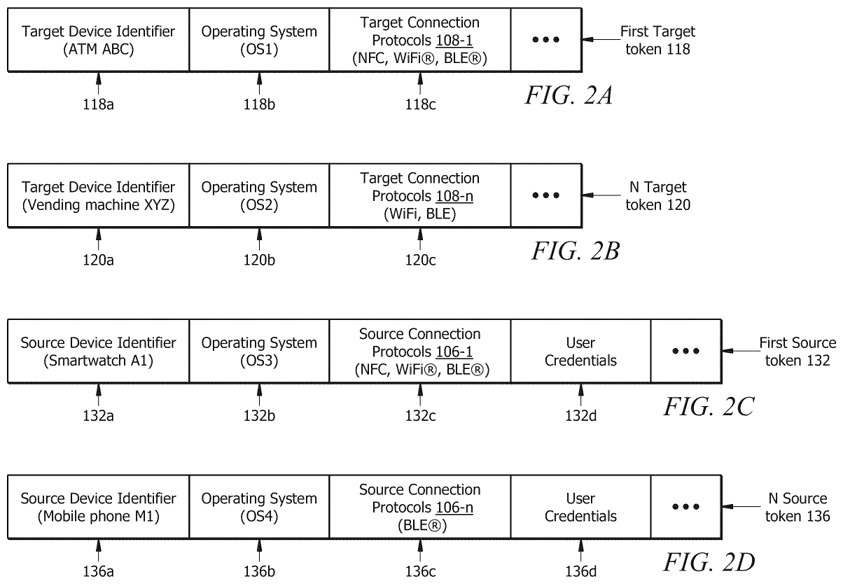

Further, each of the source devices 110-1 to 110-n includes source connection protocols (e.g., 106-1 to 106-n). The source connection protocols (e.g., 106-1 to 106-n) may include, for example, a Bluetooth® connection protocol, an NFC connection protocol, a WiFi® connection protocol, and/or a Bluetooth Low Energy (BLE®) connection protocol, although any other communication means utilized by the source devices 110 to communicate with the target devices 112 may also be included. For example, source device 110-1 includes a first set of source connection protocols 106-1 that include (with reference to FIG. 2C) an NFC connection protocol, a WiFi® connection protocol, and/or a Bluetooth Low Energy (BLE®) connection protocol. Accordingly, the source device 110-1 is only compatible with the first set of source connection protocols 106-1. Further, source device 110-n includes (with reference to FIG. 2D) a second set of source connection protocols 106-n, that include, for example, a Bluetooth Low Energy (BLE®) connection protocol. Accordingly, the source device 110-n is only compatible with the second set of source connection protocols 106-n.

### Target Device

System 100 includes target devices 112-1 to 112-n, these are collectively referred to as target device 112. The target devices 112-1 to 112-n may generally be any wired and/or wireless device configured to transmit/receive radio signals using NFC®, Bluetooth®, dedicated short-range communications (DSRC®), RFID®, universal serial bus (USB®), Wi-Fi®, etc. target devices 112-1 to 112-n may also include but are not limited to, a card reader device, an automated teller machine (ATM), a parking meter, a vending machine, a thermostat, washing machine, a point of sale (POS) device, a personal computer, a desktop computer, a workstation, a laptop, a tablet computer, a mobile phone (such as a smartphone), an Internet-of-Things (IoT) device, or any other suitable type of device. Each target device 112 includes a user interface (e.g., 122-1 to 122-n), for example, user interface 122-1 is associated with target device 112-1, and user interface 122-n is associated with target device 112-n. Target devices 112-1 to 112-n may include a display, a microphone, a camera, a keypad, or other appropriate terminal equipment usable by a user. Target devices 112-1 to 112-n are utilized to perform wireless interactions with source devices 110-1 to 110-n.

### Target Connection Protocols

Further, each of the target devices 112 includes target connection protocols (e.g., 108-1 to 108-n). The target connection protocols (e.g., 108-1 to 108-n) may include, for example, a Bluetooth® connection protocol, an NFC connection protocol, a WiFi® connection protocol and/or a Bluetooth Low Energy (BLE®) connection protocol, although any other communication means utilized by the target devices 112 to communicate with the source devices 110 may also be included. For example, target device 112-1 includes a first set of target connection protocols 108-1 that include (with reference to FIG. 2A) an NFC connection protocol, a WiFi® connection protocol, and/or a Bluetooth Low Energy (BLE®) connection protocol. Accordingly, the target device 112-1 is only compatible with the first set of target connection protocols 108-1. Further, target device 112-n includes a second set of target connection protocols 108-n (with reference to FIG. 2B), a WiFi® connection protocol and/or a Bluetooth Low Energy (BLE®) connection protocol. Accordingly, the target device 112-n is only compatible with the second set of target connection protocols 108-n.

### Server Device

The server device 114 includes a processor 134 in signal communication with a memory 128. Memory 128 stores software instructions 140 that, when executed by processor 134, cause processor 134 to perform one or more operations of the server device 114 described herein. The server device 114 further includes a network interface 142. Further, processor 134 is operably coupled to memory 128.

### Network

Network 116 may be any suitable type of wireless and/or wired network. The network 116 may be connected to the Internet or public network. Network 116 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 116 may be configured to support any suitable type of communication protocol, as would be appreciated by one of ordinary skills in the art.

### Network Interface

Network interface 142 is configured to enable wired and/or wireless communications. The network interface 142 may be configured to communicate data between the server device 114 and source devices 110-1 to 110-n, target devices 112-1 to 112-n, and other systems, domains, or devices. For example, the network interface 142 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 134 may be configured to send and receive data using the network interface 142. The network interface 142 may be configured to use any suitable type of communication protocol.

### Memory

The memory 128 may be volatile or non-volatile and may comprise read-only memory (ROM), random-access memory (RAM), ternary content-addressable memory (TCAM), dynamic random-access memory (DRAM), and static random-access memory (SRAM). The memory 128 may include one or more of a local database, a cloud database, a network-attached storage (NAS), etc. The memory 128 comprises one or more disks, tape drives, or solid-state drives, and may be used as an over-flow data storage device, to store programs when such programs are selected for execution, and to store instructions and data that are read during program execution. The memory 128 may store any of the information described in FIGS. 1-3 along with any other data, instructions, logic, rules, or code operable to implement the function(s) described herein when executed by processor 134. For example, the memory 128 may store a token database 130, network parameters 138, software instructions 140, artificial intelligence (AI) algorithm 144, rules database 152, and/or any other data or instructions. The software instructions 140 may include any suitable set of instructions, logic, rules, or code operable to execute the processor 134 and perform the functions described herein, such as some or all of those described in FIGS. 1-3. Further, source device 110-1 may include an application installed in it that is in communication with the server device 114, and the processor 134 is configured to execute the application on the source device 110-1 to perform the operations described in FIGS. 1-3.

### Monitor Actions and Determine its Operation Corresponding to the Action

Processor 134 of the server device 114 is configured to monitor actions on the source devices 110-1 to 110-n. In one embodiment, the source device 110-1 is a smartwatch 110-1, and the target device 112-1 is an ATM 112-1. Source device 110-1 is interchangeably referred to as smartwatch 110-1, and the target device 112-1 is interchangeably referred to as ATM 112-1. When a user 102-1 of the source device 110-1 intends to perform a check account balance operation (e.g., bank account balance) at the target device 112-1 (i.e., an ATM 112-1) using source device 110-1 (i.e., smartwatch 110-1). The user 102-1 may perform the first action of, for example, rotating a dial of the smartwatch 110-1 in a clockwise direction. In response to the user's first action, the processor 134 accesses rules stored in the rules database 152 to determine if the first action is included in the rules database 152. The rules database 152 stores one or more rules for each of the actions. For example, in response to determining a first action, the rule associated with the first action corresponds with a first operation to be performed. In response to determining the first action is included in the rules database 152, the processor 134 determines a first operation associated with the first action. For example, the first action of rotating a crown button of the smartwatch 110-1 in a clockwise direction corresponds to a first operation (also referred to as first wireless interaction) of checking an account balance operation from the plurality of target devices 112-1 to 112-n (including the ATM 112-1). Source devices 110-1 to 110-n are utilized to perform wireless interactions with target devices 112-1 to 112-n. For example, wireless interactions may be a data exchange between source devices 110 and target devices 112. For example, when the source device 110-1 is a mobile phone, and the target device 112-1 is an ATM 112-1, the wireless interaction may be an operation performed by a user 102-1 using the source device 110-1 (e.g., a mobile phone) to wirelessly (on the source device 110-1) check account balance associated with the user 102-1 stored at the target devices 112 (e.g., an ATM 112-1). Further, in response to determining that the first action is not included in the rules database 152, processor 134 does not take any action.

Accordingly, in conjunction with monitoring the actions at source device 110-1, processor 134 determines that the action comprises a first wireless interaction with a plurality of target devices 112-1 to 112-n.

### Rules Database

The rules database 152 includes a plurality of rules, and each rule is associated with a corresponding operation to be performed. For example, a second action of rotating a crown button of the smartwatch 110-1 in an anti-clockwise direction has a second rule corresponding to a second operation of withdrawing cash from a bank account from one or more source devices 112 (e.g., ATM 112-1).

Similarly, in another example, a third action of pressing a crown button of the smartwatch 110-1 two times corresponds to a third operation of making a purchase of a product at a target device 112-1 (for example, target device 112-1 is a vending machine). In this example, when the source device 110-1 is a mobile phone, and the target device 112-1 is a vending machine, the wireless interaction may be an operation performed by a user 102-1 using the source device 110-1 (e.g., a mobile phone) to wirelessly purchase (via the source device 110-1) a product (e.g., a snack item) stored within target devices 112-1 to 112-n (including the target device 112-1 which is a vending machine). In another example, a fourth action of pressing a crown button of the smartwatch 110-1 three times corresponds to a fourth operation of paying for parking at a target device 112-1 (for example, target device 112-1 is a parking meter). Any other action performed on the source devices 110 and its corresponding operation may be included in the rules database 152. In this example, when the source device 110-1 is a mobile phone, and the target device 112-1 is a parking meter, the wireless interaction may be an operation performed by a user 102-1 using the source device 110-1 (e.g., a mobile phone) to wirelessly (via the source device 110-1) pay for parking at one or more target device 112s (for example, target device 112-1 is a parking meter).

### Identify a First Target Device and a Second Target Device

When processor 134 determines that the first action comprises the first operation of checking an account balance operation from the plurality of target devices 112-1 to 112-n, then processor 134 determines to identify all the target devices 112 that are within a threshold distance to the source device 110-1 (e.g., smartwatch 110-1). For example, processor 134 utilizes one or more of the first set of the source connection protocols 106-1 to determine target devices 112 that are within a threshold distance to the smartwatch 110-1. For example, first set of the source connection protocols 106-1 includes a Bluetooth® connection protocol, an NFC connection protocol, a WiFi® connection protocol, and/or a Bluetooth Low Energy (BLE®) connection protocol. Processor 134 may utilize one of the connection protocols or all of the connection protocols to identify target devices 112 that are within a threshold distance. For example, when processor 134 utilizes the BLE® connection protocol, then the threshold range of communication associated with the BLE® connection protocol is the threshold distance within which all the target devices 112 (e.g., target device 112-1 and target device 112-n) will be identified. In this example, since target devices 112-1 and target devices 112-n are within the threshold distance, target devices 112-1 and target devices 112-n are identified.

In another example, processor 134 is configured to utilize the BLE® connection protocol to identify any of target devices 112 within the threshold distance, and if the processor 134 is unable to identify any of the target devices 112, then the processor 134 is configured to utilized the NFC connection protocol to identify target devices 112 that are within a threshold range of communication associated with the NFC connection protocol. Further, when processor 134 utilizes the NFC connection protocol and is unable to identify any of the target devices 112-1, processor 134 is configured to utilize the WiFi® connection protocol to identify target devices 112 that are within a threshold range of communication associated with the WiFi® connection protocol.

### Query Request

In response to identifying target devices 112-1 and target devices 112-n within a threshold distance of the source device 110-1, processor 134 is configured to transmit a query request to each of the target device 112-1 and the target device 112-n. The query request seeks identifying information from the target device 112-1 and the target device 112-n. The query request may be a broadcast request, requesting identifying information from the target device 112-1 and the target device 112-n.

In response to transmitting the query request, processor 134 is configured to receive a first target device identifier 118a from the target device 112-1, and a second target device identifier 120a is received from the second target device 112-n. The first target device identifier 118a, is an identifier that uniquely identifies the target device 112-1. For example, the first target device identifier 118a may be “ATM ABC.” The second target device identifier 120a is an identifier that uniquely identifies the second target device 112-n. For example, the second target device identifier 120a may be “Vending machine XYZ.”

In another embodiment, processor 134 is configured to receive the first target device identifier 118a as part of a first target token 118 from the target device 112-1. Additionally, also receives the second target device identifier 120a as part of an n-target token 120 from the target device 112-n. The first target token 118 and the n-target token 120, are explained in detail below with reference to FIGS. 2A & 2B, respectively.

Upon receiving the first target device identifier 118a and the second target device identifier 120a, processor 134 is configured to display the first target device identifier 118a and the second target device identifier 120a on the user interface 104-1 of the source device 110-1. The first target device identifier 118a and the second target device identifier 120a may be displayed as a list on the user interface 104-1.

Further, the processor 134 is configured to receive a selection of the first target device identifier 118a based on an input received from the source device 110-1. For example, user 102-1 may view the displayed list on the user interface 104-1, including the first target device identifier 118a and the second target device identifier 120a, and may rotate the crown button of the smartwatch 110-1 to make the selection of the first target device identifier 118a from the displayed list.

### Transmit Initiation Request

In response to receiving the selection of the first target device identifier 118a, processor 134 is configured to transmit, via the source device 110-1, a connection initiation request to the target device 112-1. The connection initiation request is a request to initiate a temporary mesh network connection 124-1 between the source device 110-1 and the target device 112-1.

### First Target Token

In response to transmitting the connection initiation request to the target device 112-1, processor 134 is configured to receive a first target token 118 from the target device 112-1. With reference to FIG. 2A, the first target token 118 includes a target device identifier 118a (e.g., ATM ABC), an operating system identifier 118b (e.g., OS1), and one or more target connection protocols 118c (e.g., a first set of target connection protocols 108-1) that are compatible with the target device 112-1. The operating system identifier 118b (e.g., OS1, i.e. a first environment) is the software platform identifier that is utilized by the target device 112-1.

In embodiment, the processor 134 is configured to receive a selection of the second target device identifier 120a based on an input received from the source device 110-1. Next, processor 134 is configured to transmit a connection initiation request to the target device 112-n. In response to transmitting a connection initiation request to the target device 112-n, receive an n-target token 120 from the target device 112-n. With reference to FIG. 2B, the n-target token 120 includes a target device identifier 120a (e.g., Vending machine XYZ), an operating system identifier 120b (e.g., OS2, i.e. a second environment), and one or more target connection protocols 120c (e.g., a second set of target connection protocols 108-n) that are compatible with the target device 112-n.

### Token Database

Upon receiving the first target token 118, the processor 134 is configured to store the first target token 118 in the token database 130. Similarly, upon receiving the n-target token 120, the processor 134 is configured to store the n-target token 120 in the token database 130. Processor 134 is configured to store all the target tokens (e.g., first target token 118 and n-target token 120) received from each of the target devices 112.

In another embodiment, in conjunction with monitoring actions on the source devices 110, processor 134 is configured to, for example, transmit a request to each of the source devices 110 (e.g., source device 110-1) to request their corresponding source token (e.g., first source token 132) and store it in the token database 130. Token database 130 stores a first source token 132 associated with source device 110-1 and n-source token 136 associated with source device 110-n. The token database 130 stores all source tokens (e.g., first source token 132 and n-source token 136) associated with each of the source devices 110.

With reference to FIG. 2C, the first source token 132 includes a source device identifier 132a (e.g., Smartwatch A1), an operating system identifier 132b (e.g., OS3), one or more source connection protocols 132c (e.g., a first set of source connection protocols 106-1) that are compatible with the source device 110-1, and user credentials 132d. The operating system identifier 132b (e.g., OS3) is the software platform identifier that is utilized by the source device 110-1. The user credentials 132d include the user password, login name, account identifier, or any information that can be utilized to authenticate the user 102-1 of the source device 110-1.

### End to End Encryption

In an embodiment, back when the connection initiation request is transmitted by the processor 134, the connection initiation request includes an encrypted first source token 132. The encrypted first source token 132 includes user credentials 132d.

The source device 110-1 encrypts the first source token 132 by utilizing a private-public key pair. The source device 110-1 utilizes an encryption algorithm (e.g., RSA (Rivest-Shamir-Adleman) or Elliptic curve cryptography) to encrypt the first source token 132 using a public key. The target device 112-1 stores a private key to decrypt the first source token 132. Upon receiving the first source token 132, the target device 112-1 applies a decryption algorithm (e.g., RSA (Rivest-Shamir-Adleman) or Elliptic curve cryptography) that utilizes the stored private key to decrypt the received first source token 132 using the stored private key. The target device 112-1 utilizes the user credentials to match it against previously stored user credentials. In response to successfully authenticating the user credentials of the source device 110-1, target device 112-1 transmits an encrypted first target token 118 to the source device 110-1. Target device 112-1 utilizes an encryption algorithm (e.g., RSA (Rivest-Shamir-Adleman) or Elliptic curve cryptography) to encrypt the first target token 118 using a public key. The source device 110-1 stores the private key to decrypt the first target token 118. Source device 110-1 receives the first target token 118, and processor 134 applies a decryption algorithm (e.g., RSA (Rivest-Shamir-Adleman) or Elliptic curve cryptography) that utilizes the stored private key to decrypt the received first target token 118 using the stored private key and extract the information from the first target token 118 (e.g., one or more target connection protocols 118c). Accordingly, the first target token 118 received from the target device 112-1 is received over an end-to-end encrypted path. In another embodiment, the operations of encryption and decryption at target device 112-1 may performed by processor 134.

### Compare Target Connection Protocols With Source Connection Protocols

In response to receiving the first target token 118, processor 134 is configured to compare one or more target connection protocols 118c (e.g., the first set of target connection protocols 108-1) that are compatible with the target device 112-1 with one or more source connection protocols 132c (e.g., a first set of source connection protocols 106-1) that are compatible with the source device 110-1.

In this example, the first set of target connection protocols 108-1 include NFC, WiFi®, and BLE®, and the first set of source connection protocols 106-1 include NFC, WiFi®, and BLE. Thus, processor 134 is configured to determine that all three connection protocols NFC, WiFi®, and BLE® are common to one or more target connection protocols 118c and one or more source connection protocols 132c. Thus, the connection protocols NFC, WiFi®, and BLE® are identified as common connection protocols.

### Select Particular Common Connection Protocol

Next, processor 134 is configured to monitor network parameters 138 associated with the identified common connection protocols NFC, WiFi®, and BLE®. The network parameters are associated with monitoring connection protocol network conditions. Network parameters may include a number of source devices 110 wirelessly connected to the target device 112-1 on each of the common connection protocols associated with the target device 112-1 and/or a network latency associated with each of the common connection protocols associated with the target device 112-1, although any another network parameter may be included to monitor connection protocol network conditions.

Further, processor 134 determines that the number of source devices 110 wirelessly connected to the target device 112-1 on each of the connection protocols NFC, WiFi®, and BLE®. For example, processor 134 determines the number of source devices 110 wirelessly connected to the target device 112-1 on the first common connection protocol (e.g., NFC) is 4 devices, on the second common connection protocol (e.g., WiFi®) is 100 devices and on the third common connection protocol (e.g., BLE® is 50 devices. Processor 134 is configured to select the common connection protocol that has the lowest number of devices. Accordingly, processor 134 determines that the first common connection protocol (e.g., NFC) that has 4 devices is the lowest number of devices that are wirelessly connected to the target device 112-1 over the other common connection protocols NFC and WiFi®. Thus, processor 134 selects the first common connection protocol (e.g., NFC).

Accordingly, in response to determining that there are any connection protocols (e.g., the identified common connection protocols NFC, WiFi®, and BLE®) that are common to both the common to one or more target connection protocols 118c and one or more source connection protocols 132c, then processor 134 selects a particular common connection protocol (e.g., first common connection protocol (e.g., NFC)) based at least in part upon one or more network parameters (e.g., number of source devices 110 wirelessly connected to the target device 112-1) associated with the one or more target connection protocols 118c.

In another embodiment, processor 134 determines network latency associated with each of the connection protocols NFC, WiFi®, and BLE®. Network latency is measured by the time (in milliseconds (ms)) it takes for data to travel from one point to another on a network. For example, processor 134 determines the network latency on the first common connection protocol (e.g., NFC) is 20 ms, the network latency on the second common connection protocol (e.g., WiFi®) is 40 ms, and the network latency on the third common connection protocol (e.g., BLE® is) is 5 ms. Processor 134 is configured to select the common connection protocol that has the smallest latency time. Accordingly, processor 134 determines that the third common connection protocol (e.g., BLE®) that has a latency of 5 ms has the latency time over the other common connection protocols NFC, and WiFi®. Thus, processor 134 selects the third common connection protocol (e.g., BLE®).

### Initiate the Temporary Mesh Network Connection

In response to processor 134 selecting a particular common connection protocol (e.g., first common connection protocol (e.g., NFC)), processor 134 initiates the temporary mesh network connection 124-1 between the source device 110-1 and the target device 112-1 using the particular common connection protocol (e.g., first common connection protocol (e.g., NFC)). Upon initiation of the temporary mesh network connection 124-1, the processor 134 allows the source device 110-1 to perform the first wireless interaction (e.g., check account balance or any data exchange) with the target device 112-1 using the temporary mesh network connection 124-1.

In another embodiment, temporary mesh network connection 124-1 may utilize a transport layer security protocol (e.g., TLS 1.3) that provides end-to-end encryption for all the data exchanged between the source device 110-1 and the target device 112-1 in the temporary mesh network connection 124-1. Thus, temporary mesh network connection 124-1 is an end-to-end encrypted temporary mesh network connection 124-1.

### Multiple Dedicated Mesh Network Connections

After the temporary mesh network connection 124-1 is established, source device 110-n (i.e., a second source device 110-n) initiates connecting with the target device 112-1 to establish a second temporary mesh network connection 124-2 between the source device 110-n and the target device 112-1. The second temporary mesh network connection, 124-2, and the temporary mesh network connection, 124-1, are both active simultaneously. The advantage of simultaneously connecting to the target device 112-1 is that both the source devices 110-1 and 110-n can perform their wireless operations with the target device 112-1 at the same time, thus providing optimized utilization of network resources (e.g., network bandwidth) associated with the target device 112-1.

### Initiate a Second Temporary Mesh Network Connection

As described above, with reference to source device 110-1 initiating or establishing the temporary mesh network connection 124-1 with the target device 112-1. Similarly, source device 110-n initiates a secondary temporary mesh network connection 124-2 with the target device 112-1.

In an embodiment, processor 134 is configured to monitor actions on the source device 110-n. The actions on the source device 110-n may be performed by user 102-n. In conjunction with the monitoring of the actions on the source device 110-n, processor 134 determines that the actions correspond to a second operation of dispensing cash at ATM 112-1 by performing a second wireless interaction with a plurality of target devices 112-1 to 112-n, including the ATM 112-1.

Processor 134 identifies the target device 112-1 and the target device 112-n from the plurality of target devices 112-1 to 112-n as being within a first threshold distance to the source device 110-n. In response to identifying the target device 112-1 and the target device 112-n, processor 134 transmits a second query request to each of the target device 112-1 and the target device 112-n. The second query request seeks identifying information from target device 112-1 and the target device 112-n. Further, processor 134 receives the first target device identifier 118a from the target device 112-1 and the second target device identifier 120a from the target device 112-n. Processor 134 then displays a list including the first target device identifier 118a and the second target device identifier 120a on the source device 110-n. Processor 134 then receives another selection of the first target device identifier 118a based on another input received from the source device 110-n. Another selection of the first target device identifier 118a may be performed by user 102-n selecting the first target device identifier 118a from the displayed list. In response to receiving another selection of the first target device identifier 118a, processor 134 transmits a second connection initiation request to the target device 112-1.

The second connection initiation request is to initiate a temporary mesh network connection 124-2 between the source device 110-n and the target device 112-1. In response to transmitting the second connection initiation request to the target device 112-1, processor 134 is configured to receive the first target token 118 from the target device 112-1. In response to receiving the first target token 118, processor 134 compares the first set of target connection protocols 108-1 (including the NFC, WiFi®, BLE® connection protocols) with the second set of source connection protocols 106-n (including BLE® connection protocol). In response to the comparison, processor 134 determines if there are any other connection protocols that are common to both the first set of target connection protocols 108-1 and the second set of source connection protocols 106-n. Accordingly, based on the comparison, the processor 134 determines that BLE connection protocol is a common connection protocol (also referred to as second particular common connection protocol). In this embodiment, since there is only one common connection protocol i.e., the BLE connection protocol, hence the processor 134 does not utilize network parameters associated with the first set of target connection protocols 108-1.

In response to selecting the second particular common connection protocol (i.e., BLE connection protocol), processor 134 initiates the temporary mesh network connection 124-2 between the source device 110-n and the target device 112-1 using the second particular common connection protocol (i.e., BLE connection protocol). The target device 112-1 is connected to the source device 110-n using the temporary mesh network connection 124-2 and simultaneously the target device 112-1 is connected to the source device 110-1 using the temporary mesh network connection 124-1. The processor 134 then performs the second wireless interaction of dispensing cash at the ATM 112-1 using the temporary mesh network connection 124-2.

### Generate User Interface Based on Historical Wireless Interaction Data

The artificial intelligence (AI) algorithm 144 is using two data sets. The first data set is collected to include a dataset of the plurality of user interfaces associated with their corresponding operations (user interface associated with check account balance operation or cash dispensation operation). Annotations are applied to each of the user interfaces included in the first data set. The annotations indicate those user interfaces that a user selects more than a threshold number of times. A first training set is created including the annotated user interfaces and non-annotated user interfaces. The AI algorithm 144 is trained using the annotated user interfaces and non-annotated user interfaces to identify those user interfaces the user selects more than a threshold number of times. A second training set is created for a second stage of training comprising the first training set and user interfaces that are incorrectly detected as the user interface a user selects more than a threshold number of times after the first stage of training. The AI algorithm 144 is re-trained in a second stage using the second training set to generate a trained AI algorithm 144.

The AI algorithm 144 may include a support vector machine, machine learning, neural network, random forest, a large language model (LLM) algorithm, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 144 may include a data processing machine learning algorithm that is configured to detect the user interface a user selects more than a threshold number of times. The AI algorithm 144 may be implemented by supervised, semi-supervised, and/or unsupervised machine learning. In another embodiment, processor 134 executes the AI algorithm 144, to perform one or more operations of detecting the user interface a user selects more than a threshold number of times. In another embodiment, processor 134 executes software instructions 140 and is configured to detect the user interface a user selects more than a threshold number of times without utilizing AI algorithm 144.

In response to initiating the first wireless interaction on the source device 110-1, processor 134 executes an AI algorithm 144 using the historical wireless interaction data 150 performed by the source device 110-1 as a first input. The AI algorithm 144 is configured to detect a user interface that a user selects more than a threshold number of times and generate a first user interface (e.g., user interface 105-1) at the source device 110-1 as a first output. The historical wireless interaction data 150 includes data associated with the most selected user interfaces by the user 102-1 of the source device 110-1. For example, a user 102-1, while performing a check account balance in a past time period, selects the option to “view balance” 9 out of 10 times. Upon selecting the “view balance” option, the user interface 105-n is generated on the source device 110-1. Another example is when a user 102-1, while purchasing a product at a vending machine in a past time period, selects the option to purchase “water bottle” 8 out of 10 times. Upon selecting the purchase option, the user interface 105-n is generated on the source device 110-1. When the AI algorithm 144 receives this historical wireless interaction data 150 as input, it is trained to identify the operation associated with the first wireless interaction (e.g., check account balance) and in response to identifying that the operation associated with first wireless interaction is to check the account balance, then AI algorithm 144 generates the user interface 105-n associated with the “view balance” on the source device 110-1.

Similarly, in response to initiating the second wireless interaction on the source device 110-n, execute the AI algorithm 144 using historical wireless interaction data 150 performed by the source device 110-n as a second input, wherein the AI algorithm 144 is configured to detect a user interface that a user selects more than a threshold number of times and generate a second user interface (e.g., user interface 105-n) at the source device 110-n as a second output. For example, a user 102-2, while performing a cash dispensation operation in a past time period, selects the option to “withdraw $100”9 out of 10 times. Upon selecting the “withdraw $100” option, the user interface 105-n is generated on the source device 110-n. When the AI algorithm 144 receives this historical wireless interaction data 150 performed by the source device 110-n as an input, it is trained to identify the operation associated with the second wireless interaction (e.g., cash dispensation) and in response to identifying that the operation associated with second wireless interaction is cash dispensation, then AI algorithm 144 generates the user interface 105-n associated with the “withdraw $100” on the source device 110-n.

### Simultaneous Account Balance Request

Processor 134 is configured to generate a first resource amount request in response to an input received from the source device 110-1. The first resource amount request is a request to check the account balance at the ATM 112-1 for a bank account associated with user 102-1 of source device 110-1. This request is generated in response to selecting the “view balance” option on the first user interface 105-1 associated with the source device 110-1. Processor 134 transmits the first resource amount request (e.g., a request to check account balance) to the target device 112-1 at a first time period T1. In response to transmitting the first resource amount request to the target device 112-1, Processor 134 is configured to receive from the target device 112-1 a first value (e.g., the account balance amount of “$500”) associated with the first resource amount request on the source device 110-1. Processor 134 is configured to display on the first user interface 105-1 a first value ($500) associated with the first resource amount request on the source device 110-1. The first value ($500) is received from the target device 112-1 using the temporary mesh network connection 124-1 between the source device 110-1 and the target device 112-1.

Next, processor 134 is configured to generate a request for a second resource amount in response to an input received on the source device 110-n. The second resource amount request is a request to check the account balance at the ATM 112-1 for a bank account associated with user 102-2 of source device 110-n. This request is generated in response to selecting the “view balance” option on the user interface 105-n associated with the source device 110-n. Processor 134 transmits the second resource amount request (e.g., a request to check account balance) to the target device 112-1 at a time period T2, where T2 is after T1, however, T2 starts before processor 134 displays on the first user interface 105-1 the first value ($500) associated with the first resource amount request on the source device 110-1. In response to transmitting the second resource amount request to the target device 112-1, Processor 134 is configured to receive from the target device 112-1 a second value (e.g., the account balance amount of “$7000”) associated with the second resource amount request on the source device 110-n. Processor 134 is configured to display on the user interface 105-n a second value ($7000) associated with the second resource amount request on the source device 110-n. The second value ($7000) is received from the target device 112-1 using the temporary mesh network connection 124-2 between the source device 110-n and the target device 112-1.

### Simultaneous Cash Dispensation Request

In response to initiating the first wireless interaction on the source device 110-1, processor 134 is configured to generate a first resource dispensation request in response to an input received from the source device 110-1. In this example, the first resource dispensation request is a cash dispensation request sent to the ATM 112-1 from user 102-1, selecting the “withdraw $100” option on the first user interface 105-1 of the source device 110-n. Processor 134 is configured to transmit the first resource dispensation request to the target device 112-1 at a time period T3. In response to transmitting the first resource dispensation request, processor 134 is configured to receive a first start request (from target device 112-1) on the source device 110-1 to start the first resource dispensation request on the target device 112-1. Source device 110-1 transmits a first resource dispensation initiation request by receiving an input of selection of a start button on the first user interface 105-1. Upon completion of the cash dispensation at the ATM 112-1, the temporary mesh network connection 124-1 between the source device 110-1 and the target device 112-1 is terminated.

Next, in response to initiating the second wireless interaction on the source device 110-n, generate a second resource dispensation request in response to an input received from the source device 110-n. In this example, second resource dispensation request is a cash dispensation request sent to the ATM 112-1 from user 102-2 selecting the “withdraw $100” option on the user interface 105-n of the source device 110-n. Processor 134 is configured to transmit the second resource dispensation request to the target device 112-1 at a time period T4 after the time period T3, and before receiving the first start request to start the first resource dispensation request on the target device 112-1. In response to transmitting the second resource dispensation request to the target device 112-1, receive a queue position indicator from the target device 112-1, wherein the queue position indicator indicates an estimated wait time (e.g., 5 minutes) to initiate the second resource dispensation request at the target device 112-1 after the first resource dispensation request is completed. In response to transmitting the second resource dispensation request, processor 134 is configured to receive a second start request (from target device 112-1) on the source device 110-n to start the second resource dispensation request on the target device 112-1 after the completion of the estimated wait time. Source device 110-n transmits a second resource dispensation initiation request by receiving an input of the selection of a start button on the user interface 105-n. The second start request is received after the completion of the estimated wait time and after the temporary mesh network connection 124-1 between the source device 110-1 and the target device 112-1 is terminated.

In an embodiment, processor 134 is configured to determine when target devices 112-1 and 112-n are within a threshold distance of the source device 110-1. Thus, in this embodiment, the target devices 112-1 and 112-n may be identified to be within a threshold distance of the source device 110-1 without monitoring for actions performed on the source device 110-1. The threshold distance is the range associated with each of the first set of the source connection protocols 106-1 associated with the source device 110-1 and each of the target connection protocols 108-n associated with the target device 112-n. The processor is configured to initiate temporary mesh network connection between the source device 110-1 and target device 112-1 (as explained above).

In an embodiment, when processor 134 of the server device 114 executes a software application installed on target devices 112-1 and 112-n to determine if a source device 110-1 is within a threshold distance to the target devices 112-1 and 112-n. This threshold distance is the range associated with each of the target connection protocols 108-1 associated with the target device 112-1 and each of the target connection protocols 108-n associated with the target device 112-n. Further, in response to determining that the source device 110-1 is within the threshold distance to the target devices 112-1 and 112-n, processor 134 is configured to transmit first target token 118 (including the target device identifier 118a “ATM ABC”) from the target device 112-1 to source device 110-1 and transmit n-target token 120 (including the target device identifier 120a “Vending machine XYZ”) from the target device 112-n to source device 110-1. Further, the target device identifier 118a and the target device identifier 120a are displayed on the source device 110-1 and processor 134 is configured to receive a selection of the first target device identifier 118a based on an input received from the source device 110-1, and initiate temporary mesh network connection between the source device 110-1 and target device 112-1 (as explained above).

### Example Methods for Generating Dedicated Temporary Mesh Network Connections Between Multi-environment Systems

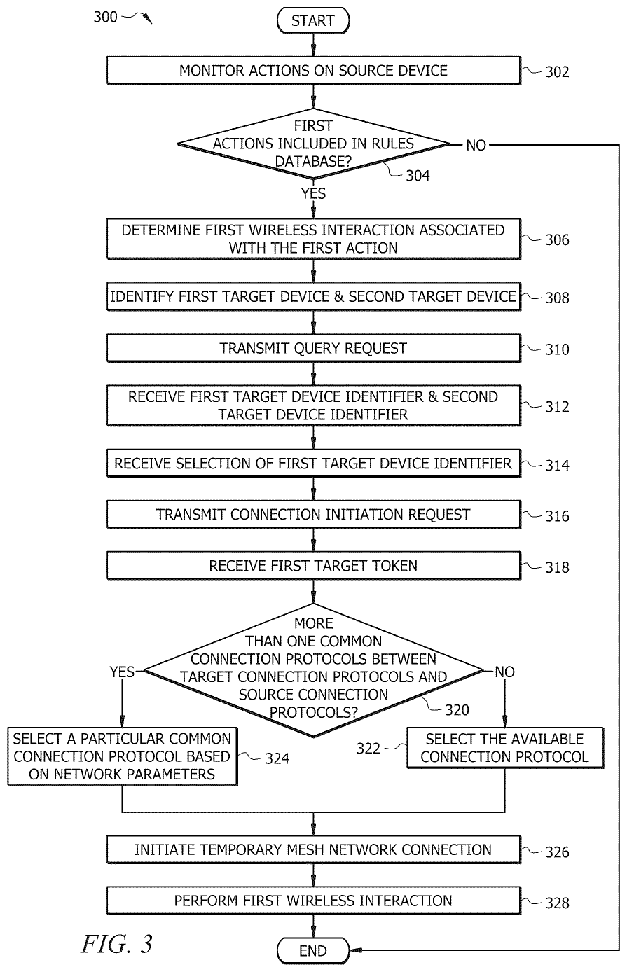

FIG. 3 illustrates an example flowchart of method 300 for generating dedicated temporary mesh network connections between multi-environment systems, in accordance with an embodiment of the present disclosure. For example, one or more operations of method 300 may be implemented, at least in part, in the form of software instructions 140 of FIG. 1, stored on a tangible non-transitory machine-readable medium or a computer-readable medium (e.g., memory 128 of FIG. 1) that, when run by one or more processors (e.g., processor 134 of FIG. 1) may cause the one or more processors to perform operations of the method 300.

Referring to FIG. 3, at operation 302, processor 134 of the server device 114 is configured to monitor actions on the source devices 110-1 to 110-n. When a user 102-1 of the source device 110-1 intends to perform a check account balance operation (e.g., bank account balance) at the target device 112-1 (i.e., an ATM 112-1) using source device 110-1 (i.e., smartwatch 110-1). The user 102-1 may perform the first action of, for example, rotating a dial of the smartwatch 110-1 in a clockwise direction

At operation 304, processor 134 of the server device 114 in response to the user's first action, processor 134 accesses rules stored in the rules database 152 to determine if the first action is included in the rules database 152. The rules database 152 stores one or more rules for each of the actions. For example, in response to determining a first action, the rule associated with the first action corresponds with a first operation to be performed. In response to determining the first action is included in the rules database 152, the method proceeds to operation 306. Back at operation 304, when processor 134 determines that the first action is not included in the rules database 152, then method ends here.

At operation 306, processor 134 determines a first operation associated with the first action. For example, the first action of rotating a crown button of the smartwatch 110-1 in a clockwise direction corresponds to a first operation (also referred to as first wireless interaction) of checking an account balance operation from the plurality of target devices 112-1 to 112-n (including the ATM 112-1).

At operation 308, processor 134 of the server device 114 identifies all the target devices 112 that are within a threshold distance to the source device 110-1 (e.g., smartwatch 110-1), in response to determining that the first action comprises the first operation of checking an account balance operation from the plurality of target devices 112-1 to 112-n.

At operation 310, processor 134 transmits a query request to each of the target device 112-1 and the target device 112-n. The query request seeks identifying information from the target device 112-1 and the target device 112-n.

At operation 312, processor 134 receives a first target device identifier 118a from the target device 112-1, and a second target device identifier 120a is received from the second target device 112-n. Processor 134 displays the first target device identifier 118a and the second target device identifier 120a on the user interface 104-1 of the source device 110-1.

At operation 314, processor 134 receives a selection of the first target device identifier 118a based on an input received from the source device 110-1.

At operation 316, processor 134 is configured to transmit, via the source device 110-1, a connection initiation request to the target device 112-1. The connection initiation request is a request to initiate a temporary mesh network connection 124-1 between the source device 110-1 and the target device 112-1.

At operation 318, processor 134 is configured to receive a first target token 118 from the target device 112-1. The first target token 118 includes a target device identifier 118a (e.g., ATM ABC), an operating system identifier 118b (e.g., OS1), and one or more target connection protocols 118c (e.g., a first set of target connection protocols 108-1) that are compatible with the target device 112-1.

At operation 320, compare one or more target connection protocols 118c (e.g., the first set of target connection protocols 108-1) that are compatible with the target device 112-1 with one or more source connection protocols 132c (e.g., a first set of source connection protocols 106-1) that are compatible with the source device 110-1, to determine if there are two or more common connection protocols.

In this example, the first set of target connection protocols 108-1 include NFC, WiFi®, and BLE®, and the first set of source connection protocols 106-1 include NFC, WiFi®, and BLE. Thus, the connection protocols NFC, WiFi®, and BLE® are identified as common connection protocols. In response to determining that there are two or more common connection protocols, then method proceeds to operation 324.

At operation 324, processor 134 is configured to monitor network parameters 138 associated with the identified common connection protocols NFC, WiFi®, and BLE®. For example, processor 134 determines that the first common connection protocol (e.g., NFC) that has 4 devices is the lowest number of devices that are wirelessly connected to the target device 112-1 over the other common connection protocols NFC and WiFi®. Thus, processor 134 selects the first common connection protocol (e.g., NFC) and the method proceeds to operation 326.

Back at operation 320, when processor 134 determines that there is only one common connection protocol (i.e., there no two or more common connection protocols), then method proceeds to operation 322. In this example, the first set of target connection protocols 108-1 include NFC, and the first set of source connection protocols 106-1 include NFC, WiFi®, and BLE. Thus, the only available common protocol (i.e., NFC connection protocol) is the common connection protocol and the method proceeds to operation 322. At operation 322, processor 134 selects the one available connection protocol (i.e., the NFC connection protocol) and proceeds to operation 326.

At operation 326, processor 134 initiates the temporary mesh network connection 124-1 between the source device 110-1 and the target device 112-1 using the particular common connection protocol (e.g., first common connection protocol (e.g., NFC)).

At operation 328, processor 134 allows the source device 110-1 to perform the first wireless interaction (e.g., check account balance or any data exchange) with the target device 112-1 using the temporary mesh network connection 124-1.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store a plurality of tokens, wherein the plurality of tokens includes a first source token associated with a source device, wherein the first source token comprises a source device identifier and one or more source connection protocols compatible with the source device; and
a processor operably coupled to the memory and configured to:
monitor one or more actions on the source device;
in conjunction with monitoring the one or more actions, determine that the one or more actions comprises a first wireless interaction with a plurality of target devices;
identify a first target device and a second target device from the plurality of target devices that are within a first threshold distance to the source device;
transmit a query request to each of the first target device and the second target device, wherein the query request seeks identifying information from the first target device and the second target device;
in response to the query request, receive a first target device identifier from the first target device and a second target device identifier from the second target device;
display the first target device identifier and the second target device identifier on the source device;
receive a selection of the first target device identifier based on an input received from the source device;
in response to receiving the selection of the first target device identifier, transmit a connection initiation request to the first target device, wherein the connection initiation request is to initiate a temporary mesh network connection between the source device and the first target device;
in response to transmitting the connection initiation request to the first target device, receive a first target token from the first target device, wherein the first target token comprises one or more target connection protocols compatible with the first target device;
in response to receiving the first target token, compare the one or more target connection protocols with the one or more source connection protocols;
in response to the comparison, determine if there are any connection protocols that are common to both the source connection protocols and the target connection protocols;
in response to determining that there are any connection protocols that are common to both the source connection protocols and the target connection protocols, select a particular common connection protocol based at least in part upon one or more network parameters associated with the target connection protocols;
in response to selecting the particular common connection protocol, initiate the temporary mesh network connection between the source device and the first target device using the particular common connection protocol; and
perform the first wireless interaction using the temporary mesh network connection.

2. The system of claim 1, wherein the plurality of tokens includes a second source token, wherein the second source token comprises a second source device identifier and a second one or more source connection protocols compatible with the second source device; and
wherein the processor is further configured to:
monitor a second one or more actions on the second source device;
in conjunction with monitoring the second one or more actions, determine that the second one or more actions comprises a second wireless interaction with a plurality of target devices;
identify the first target device and the second target device from the plurality of target devices that are within the first threshold distance to the second source device;
transmit a second query request to each of the first target device and the second target device, wherein the second query request seeks identifying information from the first target device and the second target device;
in response to the second query request, receive the first target device identifier from the first target device and the second target device identifier from the second target device;
display the first target device identifier and the second target device identifier on the second source device;
receive another selection of the first target device identifier based on another input received from the second source device;
in response to receiving the another selection of the first target device identifier, transmit a second connection initiation request to the first target device, wherein the second connection initiation request is to initiate a second temporary mesh network connection between the second source device and the first target device;
in response to transmitting the second connection initiation request to the first target device, receive the first target token from the first target device, compare the one or more target connection protocols with the second one or more source connection protocols;
in response to the comparison, determine if there are any other connection protocols that are common to both the one or more target connection protocols and the second one or more source connection protocols;
in response to determining that there are any other connection protocols that are common to both the one or more target connection protocols and the second one or more source connection protocols, select a second particular connection protocol based at least in part upon another one or more network parameters associated with the one or more target connection protocols;
in response to selecting the second particular common connection protocol, initiate the second temporary mesh network connection between the second source device and the first target device using the second particular common connection protocol, wherein the first target device is connected to the second source device using the second temporary mesh network connection and simultaneously the first target device is connected to the source device using the temporary mesh network connection; and
perform the second wireless interaction using the second temporary mesh network connection.

3. The system of claim 2, wherein the processor is further configured to:
in response to initiating the first wireless interaction on the source device, execute an artificial intelligence (AI) algorithm using one or more historical wireless interactions performed by the source device as a first input, wherein the AI algorithm is configured to generate a first user interface at the source device as a first output; and
in response to initiating the second wireless interaction on the second source device, execute the AI algorithm using another one or more historical wireless interactions performed by the second source device as a second input, wherein the AI algorithm is configured to generate a second user interface at the second source device as a second output.

4. The system of claim 3, wherein the processor is further configured to:
generate a first resource amount request in response to a third input received from the source device;
transmit the first resource amount request to the first target device at a first time period; and
in response to transmitting the first resource amount request to the first target device, display on the first user interface a first value associated with the first resource amount request on the source device, wherein the first value is received from the first target device using the temporary mesh network connection between the source device and the first target device.

5. The system of claim 4, wherein the processor is further configured to:
generate a second resource amount request in response to a fourth input received on the second source device;
transmit the second resource amount request to the first target device at a second time period, wherein the second time period is after the first time period and is before displaying on the first user interface the first value; and
in response to transmitting the second resource amount request to the first target device, display on the second user interface a second value associated with the second resource amount request on the second source device, wherein the second value is received from the first target device over the second temporary mesh network connection.

6. The system of claim 3, wherein the processor is further configured to:
in response to initiating the first wireless interaction on the source device, generate a first resource dispensation request in response to a third input received from the source device;
transmit the first resource dispensation request to the first target device at a first time period; and
in response to transmitting the first resource dispensation request, receive a first start request to start the first resource dispensation request on the first target device.

7. The system of claim 6, wherein the processor is further configured to:
in response to initiating the second wireless interaction on the second source device, generate a second resource dispensation request in response to a fourth input received from the source device;
transmit the second resource dispensation request to the first target device at a second time period after the first time period and before receiving the first start request to start the first resource dispensation request on the first target device;
in response to transmitting the second resource dispensation request to the first target device, receive a queue position indicator from the first target device, wherein the queue position indicator indicates an estimated wait time to initiate the second resource dispensation request at the first target device after the first resource dispensation request is completed; and
receive a second start request to start the second resource dispensation request at the first target device, wherein the second start request is received after the completion of the estimated wait time and after the temporary mesh network connection between the source device and the first target device is terminated.

8. A method comprising:
monitoring one or more actions on a source device;
in conjunction with monitoring the one or more actions, determining that the one or more actions comprises a first wireless interaction with a plurality of target devices;
identifying a first target device and a second target device from the plurality of target devices that are within a first threshold distance to the source device;
transmitting a query request to each of the first target device and the second target device, wherein the query request seeks identifying information from the first target device and the second target device;
in response to the query request, receiving a first target device identifier from the first target device and a second target device identifier from the second target device;
displaying the first target device identifier and the second target device identifier on the source device;
receiving a selection of the first target device identifier based on an input received from the source device;
in response to receiving the selection of the first target device identifier, transmitting a connection initiation request to the first target device, wherein the connection initiation request is to initiate a temporary mesh network connection between the source device and the first target device;
in response to transmitting the connection initiation request to the first target device, receiving a first target token from the first target device, wherein the first target token comprises one or more target connection protocols compatible with the first target device;
in response to receiving the first target token, comparing the one or more target connection protocols with the one or more source connection protocols associated with a first source token associated with a source device, wherein the first source token comprises a source device identifier and one or more source connection protocols compatible with the source device;
in response to the comparison, determining if there are any connection protocols that are common to both the source connection protocols and the target connection protocols;
in response to determining that there are any connection protocols that are common to both the source connection protocols and the target connection protocols, selecting a particular common connection protocol based at least in part upon one or more network parameters associated with the target connection protocols;
in response to selecting the particular common connection protocol, initiating the temporary mesh network connection between the source device and the first target device using the particular common connection protocol; and
performing the first wireless interaction using the temporary mesh network connection.

9. The method of claim 8, wherein the plurality of tokens includes a second source token, wherein the second source token comprises a second source device identifier and a second one or more source connection protocols compatible with the second source device; and
further comprising:
monitoring a second one or more actions on the second source device;
in conjunction with monitoring the second one or more actions, determining that the second one or more actions comprises a second wireless interaction with a plurality of target devices;
identifying the first target device and the second target device from the plurality of target devices that are within the first threshold distance to the second source device;
transmitting a second query request to each of the first target device and the second target device, wherein the second query request seeks identifying information from the first target device and the second target device;
in response to the second query request, receiving the first target device identifier from the first target device and the second target device identifier from the second target device;
displaying the first target device identifier and the second target device identifier on the second source device;
receiving another selection of the first target device identifier based on another input received from the second source device;
in response to receiving the another selection of the first target device identifier, transmitting a second connection initiation request to the first target device, wherein the second connection initiation request is to initiate a second temporary mesh network connection between the second source device and the first target device;
in response to transmitting the second connection initiation request to the first target device, receiving the first target token from the first target device, compare the one or more target connection protocols with the second one or more source connection protocols;
in response to the comparison, determining if there are any other connection protocols that are common to both the one or more target connection protocols and the second one or more source connection protocols;
in response to determining that there are any other connection protocols that are common to both the one or more target connection protocols and the second one or more source connection protocols, selecting a second particular connection protocol based at least in part upon another one or more network parameters associated with the one or more target connection protocols;
in response to selecting the second particular common connection protocol, initiating the second temporary mesh network connection between the second source device and the first target device using the second particular common connection protocol, wherein the first target device is connected to the second source device using the second temporary mesh network connection and simultaneously the first target device is connected to the source device using the temporary mesh network connection; and
performing the second wireless interaction using the second temporary mesh network connection.

10. The method of claim 9, further comprising:
in response to initiating the first wireless interaction on the source device, executing an artificial intelligence (AI) algorithm using one or more historical wireless interactions performed by the source device as a first input, wherein the AI algorithm is configured to generate a first user interface at the source device as a first output; and
in response to initiating the second wireless interaction on the second source device, executing the AI algorithm using another one or more historical wireless interactions performed by the second source device as a second input, wherein the AI algorithm is configured to generate a second user interface at the second source device as a second output.

11. The method of claim 10, further comprising:
generating a first resource amount request in response to a third input received from the source device;
transmitting the first resource amount request to the first target device at a first time period; and
in response to transmitting the first resource amount request to the first target device, displaying on the first user interface a first value associated with the first resource amount request on the source device, wherein the first value is received from the first target device using the temporary mesh network connection between the source device and the first target device.

12. The method of claim 11, further comprising:
generating a second resource amount request in response to a fourth input received on the second source device;
transmitting the second resource amount request to the first target device at a second time period, wherein the second time period is after the first time period and is before displaying on the first user interface the first value; and
in response to transmitting the second resource amount request to the first target device, displaying on the second user interface a second value associated with the second resource amount request on the second source device, wherein the second value is received from the first target device over the second temporary mesh network connection.

13. The method of claim 10, further comprising:
in response to initiating the first wireless interaction on the source device, generating a first resource dispensation request in response to a third input received from the source device;
transmitting the first resource dispensation request to the first target device at a first time period; and
in response to transmitting the first resource dispensation request, receiving a first start request to start the first resource dispensation request on the first target device.

14. The method of claim 13, further comprising:
in response to initiating the second wireless interaction on the second source device, generating a second resource dispensation request in response to a fourth input received from the source device;
transmitting the second resource dispensation request to the first target device at a second time period after the first time period and before receiving the first start request to start the first resource dispensation request on the first target device;
in response to transmitting the second resource dispensation request to the first target device, receiving a queue position indicator from the first target device, wherein the queue position indicator indicates an estimated wait time to initiate the second resource dispensation request at the first target device after the first resource dispensation request is completed; and
receiving a second start request to start the second resource dispensation request at the first target device, wherein the second start request is received after the completion of the estimated wait time and after the temporary mesh network connection between the source device and the first target device is terminated.

15. A non-transitory computer-readable medium storing instructions that, when executed by a processor, cause the processor to:
monitor one or more actions on a source device;
in conjunction with monitoring the one or more actions, determine that the one or more actions comprises a first wireless interaction with a plurality of target devices;
identify a first target device and a second target device from the plurality of target devices that are within a first threshold distance to the source device;
transmit a query request to each of the first target device and the second target device, wherein the query request seeks identifying information from the first target device and the second target device;
in response to the query request, receive a first target device identifier from the first target device and a second target device identifier from the second target device;
display the first target device identifier and the second target device identifier on the source device;
receive a selection of the first target device identifier based on an input received from the source device;
in response to receiving the selection of the first target device identifier, transmit a connection initiation request to the first target device, wherein the connection initiation request is to initiate a temporary mesh network connection between the source device and the first target device;
in response to transmitting the connection initiation request to the first target device, receive a first target token from the first target device, wherein the first target token comprises one or more target connection protocols compatible with the first target device;
in response to receiving the first target token, compare the one or more target connection protocols with the one or more source connection protocols associated with a first source token associated with a source device, wherein the first source token comprises a source device identifier and one or more source connection protocols compatible with the source device;
in response to the comparison, determine if there are any connection protocols that are common to both the source connection protocols and the target connection protocols;
in response to determining that there are any connection protocols that are common to both the source connection protocols and the target connection protocols, select a particular common connection protocol based at least in part upon one or more network parameters associated with the target connection protocols;
in response to selecting the particular common connection protocol, initiate the temporary mesh network connection between the source device and the first target device using the particular common connection protocol; and
perform the first wireless interaction using the temporary mesh network connection.

16. The non-transitory computer-readable medium of claim 15, wherein the plurality of tokens includes a second source token, wherein the second source token comprises a second source device identifier and a second one or more source connection protocols compatible with the second source device; and
wherein the instructions further cause the processor to:
monitor a second one or more actions on the second source device;
in conjunction with monitoring the second one or more actions, determine that the second one or more actions comprises a second wireless interaction with a plurality of target devices;
identify the first target device and the second target device from the plurality of target devices that are within the first threshold distance to the second source device;
transmit a second query request to each of the first target device and the second target device, wherein the second query request seeks identifying information from the first target device and the second target device;
in response to the second query request, receive the first target device identifier from the first target device and the second target device identifier from the second target device;
display the first target device identifier and the second target device identifier on the second source device;
receive another selection of the first target device identifier based on another input received from the second source device;
in response to receiving the another selection of the first target device identifier, transmit a second connection initiation request to the first target device, wherein the second connection initiation request is to initiate a second temporary mesh network connection between the second source device and the first target device;
in response to transmitting the second connection initiation request to the first target device, receive the first target token from the first target device, compare the one or more target connection protocols with the second one or more source connection protocols;
in response to the comparison, determine if there are any other connection protocols that are common to both the one or more target connection protocols and the second one or more source connection protocols;
in response to determining that there are any other connection protocols that are common to both the one or more target connection protocols and the second one or more source connection protocols, select a second particular connection protocol based at least in part upon another one or more network parameters associated with the one or more target connection protocols;
in response to selecting the second particular common connection protocol, initiate the second temporary mesh network connection between the second source device and the first target device using the second particular common connection protocol, wherein the first target device is connected to the second source device using the second temporary mesh network connection and simultaneously the first target device is connected to the source device using the temporary mesh network connection; and
perform the second wireless interaction using the second temporary mesh network connection.

17. The non-transitory computer-readable medium of claim 16, wherein the instructions further cause the processor to:
in response to initiating the first wireless interaction on the source device, execute an artificial intelligence (AI) algorithm using one or more historical wireless interactions performed by the source device as a first input, wherein the AI algorithm is configured to generate a first user interface at the source device as a first output; and
in response to initiating the second wireless interaction on the second source device, execute the AI algorithm using another one or more historical wireless interactions performed by the second source device as a second input, wherein the AI algorithm is configured to generate a second user interface at the second source device as a second output.

18. The non-transitory computer-readable medium of claim 17, wherein the instructions further cause the processor to:
generate a first resource amount request in response to a third input received from the source device;
transmit the first resource amount request to the first target device at a first time period; and
in response to transmitting the first resource amount request to the first target device, display on the first user interface a first value associated with the first resource amount request on the source device, wherein the first value is received from the first target device using the temporary mesh network connection between the source device and the first target device.

19. The non-transitory computer-readable medium of claim 18, wherein the instructions further cause the processor to:
generate a second resource amount request in response to a fourth input received on the second source device;
transmit the second resource amount request to the first target device at a second time period, wherein the second time period is after the first time period and is before displaying on the first user interface the first value; and
in response to transmitting the second resource amount request to the first target device, display on the second user interface a second value associated with the second resource amount request on the second source device, wherein the second value is received from the first target device over the second temporary mesh network connection.

20. The non-transitory computer-readable medium of claim 17, wherein the instructions further cause the processor to:
in response to initiating the first wireless interaction on the source device, generate a first resource dispensation request in response to a third input received from the source device;
transmit the first resource dispensation request to the first target device at a first time period; and
in response to transmitting the first resource dispensation request, receive a first start request to start the first resource dispensation request on the first target device.
